(19) United States
(12) Patent Application Publication
(10) Pub. No.: US 2008/0187754 A1
(43) Pub. Date: Aug. 7, 2008

(54) Composite powders comprising polymers and inorganic particles for thermal sprayed coatings

(75) Inventors: Frank N. Longo, East Northport, NY (US); Thomas Gardega, Conway, SC (US)

Correspondence Address: DILWORTH & BARRESE, LLP, 333 EARLE OVINGTON BLVD., SUITE 702, UNIONDALE, NY, 11553, US

(73) Assignee: XIOM CORPORATION

(21) Appl. No.: 12/012,085

(22) Filed: Jan. 31, 2008

Related U.S. Application Data
(60) Provisional application No. 60/898,932, filed on Feb. 1, 2007.

(51) Int. Cl. B32B 5/16; B05D 1/12

(52) U.S. Cl. 428/402.24; 427/447

(57) ABSTRACT

A particle for depositing a coating on a substrate surface by a low temperature thermal spray process having a plastic core and a particulate forming an non-continuous cladding layer around the plastic core so that enough heat can be transferred to the plastic core to cause it to melt but not so much so as to vaporize the plastic core. At the same time the particulate cladding material having a higher melting point does not melt. A particle having an inorganic core clad to a plastic outer layer is also provided. A process for making the clad material and for thermally spraying the clad material is provided. An article coated with the clad material is also provided.

### CROSS-REFERENCE TO RELATED APPLICATIONS

This application claims priority to U.S. Provisional Application Ser. No. 60/898,932 filed Feb. 1, 2007, which is herein incorporated in its entirety by reference.

### FIELD OF THE INVENTION

The present invention is directed to thermal spray compositions, and particularly to powder thermal spray compositions wherein inorganic powders are clad to plastic components to provide compositions that can be applied to either clean uncoated surfaces or coated surfaces and methods for producing the same. In addition, the present invention is directed to powder thermal spray compositions wherein inorganic powders are clad with plastic components to form particles having an inorganic core and a plastic complete or incomplete outer layer.

### BACKGROUND OF THE INVENTION

The technique of thermally spraying plastics has been available for many years. However, these chemical powders and the spray systems used to spray these powders have often been froth with practical application and physical property problems. One type of thermal spraying procedure involves high-temperature gas guns and special high temperature clad materials.

In particular, U.S. Pat. No. 5,660,934, incorporated herein in its entirety by reference, describes a high temperature thermal sprayable material, such as a metal or metal oxide that is adhered to the surface to provide a thermal barrier that allows the use of plastic in high temperature spraying. The high melting point materials that completely covers the lower melting point thermoplastic material absorbs heat while being thermally activated so as not to melt and scorch the plastic to be deposited.

U.S. Pat. No. 5,718,970, incorporated herein in its entirety by reference, describes a high temperature thermal sprayable material, such as a metal or metal oxide that is adhered to the surface of a thermal plastic particle to form a cladding layer thereon. The metal or metal oxide completely covers the thermal plastics so as to act as a temperature barrier.

Another U.S. Patent that describes a high temperature thermal sprayable material is U.S. Pat. No. 5,885,663, incorporated herein in its entirety by reference, describes combining plastic particles surrounded completely by a ceramic layer or multiple layers (inorganic). It is this layer or layers that prevent the plastic core from over heating, thereby preventing premature melting and scorching of the plastic. In other words, it is the ceramic layers surrounding the plastic core completely that acts as a thermal barrier, which absorbs at least part of the heat being applied which in turn prevents the melting and/or scorching of the plastic core.

Clad plastic particles work best when they are blended with high melting point materials such as ceramics, metal carbides and some neat metals. High melting point materials require high temperatures in order to melt where as plastic particles under the same conditions would likely overheat and/or burn. Thus, high melting point materials when completely clad (encapsulating) plastic act as a thermal barrier, which protects the plastics from high temperatures.

As stated above, all of the above referenced patents only work with high temperature plasma and high temp gas spraying guns. The high temperature is needed in order to transfer enough heat to melt the inorganic particles as well as the plastic core so that the particles can be deposited onto a surface. Accordingly, the compositions described above do not work with low temperature combustion systems since low heat transfer systems are unable to heat the thermal barrier enough to melt both it and to transfer enough heat to the encapsulated plastic so as cause it to melt as well.

For these reasons, as well as others, the above-referenced compositions do not work with low temperature thermal spray guns. Therefore, what is needed is a composition containing plastic that can be sprayed and applied to a surface under low temperature conditions without scorching/burning the plastics in the process. The compositions and processes of the claimed invention provide such compositions and therefore overcome the shortcomings of the prior art discussed above.

### SUMMARY OF THE INVENTION

The present invention provides a particle for depositing a coating on a substrate surface under low temperature conditions without scorching/burning the plastics in the process. The particle of the present invention comprises a plastic core and an inorganic particulate cladding material that is clad to the plastic core in such a way as to create an incomplete thermal barrier around the plastic core. That is, the clad particulate is attached to the plastic core so as to leave areas of the plastic core exposed so that heat can be transferred to the plastic core when heat is applied to the particle. As a result, when the particle is subjected to heat that is sufficient to melt the plastic core but insufficient to melt the outside inorganic particulate, the plastic core melts and coats the surface trapping the unmelted inorganic particulate in the melted plastic coating. The outside particulate used to incompletely clad the plastic core in general is any particulate that can be used in a cladding process and has a higher melting point than the plastic core to which it is clad.

In particular, the particulate is selected from the group consisting of ceramics and metals having a higher melting point than the plastic core. Metals used to clad to the plastic core include, but are not limited to iron, copper, nickel, cobalt, molybdenum, as well as the alloys of any of these metals, tungsten carbide, titania, chromia, Zirconia (ZrO₂), Alumina (Al₂O₃) Hafinia (HfO₂), silicon carbide, vermiculite, garnet and mixtures thereof. In addition, the cladding particulate can be metal carbides, oxides, ceramics, crushed glass, flint, sand, fiberglass and mixtures thereof. As stated above, the particulate cladding material is adhered to the plastic core to form an incomplete cladding layer around the plastic core and upon heating, enough heat is transferred to the plastic core to cause it to melt but not vaporize and the particulate cladding material having a higher melting point does not melt.

The present invention also provides an article having a thermal sprayed coating wherein the coating is obtained by providing a plurality of particles, each of the particles comprising a plastic core and a particulate cladding material selected from the group consisting of ceramics and metals having a higher melting point than the plastic core. The particulate cladding material is adhered to the plastic core forming an incomplete thermal protective cladding layer around the plastic core. When the plurality of particles are heated above the melting point of the plastic core, enough heat is transferred to the plastic core to cause it to melt but not to vaporize and the higher melting point particulate cladding material that remains unmelted is embedded in the melted plastic core applied to the article. The coating of the present invention is added to article to be coated by thermally spraying the plurality of particles on to a surface of a substrate under thermal spray conditions sufficient to melt the plastic core but not the higher melting point clad material.

The present invention also provides a method for depositing a coating on a surface of a substrate using low temperature thermal spraying comprising the following steps: (a) providing a substrate having a surface; (b) providing a clad plastic particle further comprising a plastic core and at least one particulate cladding material selected from the group consisting of metals, metal oxides, metal nitrides, metal chlorides, and metal carbides, wherein the particulate cladding material is adhered to the plastic core so as to form an incomplete non-continuous cladding layer around the plastic core so that upon heating enough heat is transferred to the plastic core to cause it to melt but not vaporize and the particulate cladding material remains unmelted; and (c) spraying an admixture comprising the clad plastic particle on a portion of the surface of the substrate with a thermal spray gun using spraying parameters sufficient to melt but not vaporize the plastic core while the cladding material remains unmelted. The process produces a coating on the surface wherein the unmelted particulate cladding material is embedded in the melted plastic core. The particle, the article and the process of the present invention together provides a coated article that includes unmelted inorganic particles, such as the metals and carbides listed above, and produce hard wear resistant surfaces that are multi-functional because of the duplex coating.

The present invention also provides a process for making a clad composition with at least two different particles clad together to form one unique particle type that can be used to coat surfaces. The process comprises dry mixing at least two different particles wherein one of the particles has a higher melting point than the other and wherein the higher melting point particles are added in an amount less than the lower melting point particle so as to assure incomplete cladding of the higher melting point particle to the lower melting point particle. The present invention also provides a particle for depositing a coating on a substrate surface by a low temperature thermal spray process comprising an inorganic core having a particle size of about having a diameter ranging from less than or equal to about 40 mesh (420 μm), preferably 80 mesh (177 μm). The particle configured so that the plastic particulate cladding material is clad to the inorganic core in either a continuous or non-continuous plastic layer. The embodiments of the present invention are described in more details in the detailed description of the invention that directly follows.

### DETAILED DESCRIPTION OF THE INVENTION

The present invention is directed to a particle wherein a plastic core is incompletely clad with inorganics, i.e., such as iron, copper, nickel, cobalt, molybdenum, as well as the alloys of any of these metals, tungsten carbide, titania, chromia, Zirconia (ZrO₂), Alumina (Al₂O₃) Hafinia (HfO₂), silicon carbide, vermiculite, garnet and mixtures thereof, to produce particles having a plastic core incompletely/non-continuously encapsulated by at least one inorganic compound from the group provided above. An essential feature of the particle of the present invention is the incomplete cladding of the plastic particle core with the higher melting point inorganic material. The coated article of the present invention uses a thermal process that provides heat that is sufficient to melt the plastic core but not the higher melting point inorganic material clad to its surface.

It is essential that the higher melting point inorganic material clad to the plastic core does not fully encapsulate the plastic core so as not to create a complete thermal barrier around the plastic core. That is, the non-continuous thermal barrier allows thermal energy to be transferred to the plastic core and thereby causing it to melt. This configuration allows the plastic core to melt but not vaporize or scorch. That is, although the plastic core is exposed to heat when it is being applied to a surface using a low temperature thermal spray process of the present invention, the plastic core does not burn or scorch since at least some of the heat is transferred to the inorganic materials partially clad to the plastic material. In other words, the inorganic particles clad to the plastic core transfers some of the heat away from the plastic core by absorbing it, but the amount of heat that is absorbed by the inorganic material is not enough to melt the inorganic particles wherein the heat that is absorbed by the plastic core is enough to melt but not vaporize the plastic core. Therefore, a low heat applicator providing enough thermal energy to melt the plastic core but not enough thermal energy to melt the inorganic material can be used to apply the particulate mixture of the present invention so as to produce coated articles having a plastic coating with unmelted inorganics dispersed throughout. This coating can be used as a reduce-wear coating as well as other applications where it is favorable to have a plastic coating with unmelted inorganic particles dispersed and embedded therein.

The plastic core can be a fluoropolymer, polyvinyl chloride, epoxy resin, polyester, polyethylene, polyamide, polyimides or mixtures thereof In particular the plastic core can be selected from the group consisting of polytetrafluoroethylene (PTFE), ethyltetrafluoroethylene (ETFE), tetrafluoroethylene (TFE), perfluoroalkoxy (PFA), Polyvinylidene Difluoride (PVDF), fluorinated ethyl propylene (FEP and mixtures thereof.

Unlike the patented methods and compositions discussed in the background of the invention section above wherein the object was to establish a complete and continuous thermal barrier around each plastic particle to prevent scorching/burning of the plastic under high temperature conditions when both the inorganic and plastic particles are melted, the object of the present invention is to produce a composition wherein at least part of the plastic core is exposed so that less heat is needed to melt the plastic core. This allows the clad particulate of the present invention to be coated onto a surface using low-heat techniques, such as thermal spraying, which cannot be used with compositions having a continuous inorganic layer clad to a plastic core since the applied heat would be insufficient to melt the thermal barrier layer produced by the inorganic material and therefore would not melt and deposit the plastic core.

Leaving at least part of the plastic core unclad as in the present invention allows enough heat to be absorbed by the plastic core during thermal spraying so as to allow it to melt and provide a coating having co-deposition of both melted plastic and unmelted clad inorganic particles onto the surface to be coated. The present compositions contrast sharply with a simple non-clad blend of plastic and metal or ceramic powders in that only the plastic particles melt and deposit under the low temperature spraying conditions. Blended high melting point inorganic particles fail to melt under low temperature conditions and usually fall through the flame. This results in a coating where the inorganic particles are not evenly dispersed throughout the deposited soft plastic film. This makes it difficult, if not impossible, to insure an evenly distributed coating as intended. Whereas the partially clad plastic particles of the present invention carry inorganic particles to the surface to be coated insuring even distribution of the inorganic or ceramic particles in the coating being applied. In other words, the inorganic particles are evenly distributed throughout the plastic coating since the low temperature system is able to melt the plastic core, but not the inorganic particles and the coating covers the surface embedding the un-melted inorganic particles evenly throughout.

One example of a partial clad composite of the present invention that can be used/applied at low temperatures comprises either polyethylene or polyester clad with about 20% by weight to about 60% by weight of the composition of vermiculite particles. The polyethylene or polyester clad with vermiculite when applied using low heat provides a surface coating that is both tough and stress free. The vermiculite can range in size from about 30 μm to about 70 μm, preferably 44 μm. Another composition of the present invention comprises either polyethylene or polyamide clad with about 20% by weight to about 75% by weight of the composition of cuprous oxide particles, preferably about 60% cuprous oxide. The cuprous oxide of this composition is about 1 μm to about 62 μm in diameter, preferably 20 μm in diameter and partially clad to the polyethylene or polyamide. Once applied to a surface using a low temperature applicator, such as the XiO™ applicator, the anti-fouling coating produced has cuprous oxide evenly dispersed throughout making for a superior anti-fouling coating as the cuprous oxide leaches from the plastic coating.

Yet another composition of the present invention comprises a polymer clad with about 2% by weight to about 20% by weight of the composition of inorganic fibers. The inorganic fibers having a diameter of about 1 μm to about 5 μm and a length of about 10 μm to about 150 μm. One type of fiber that can be used is fiberglass. This composition provides coatings having high integrity, strength and durability. Another embodiment of the present invention is a composition comprising any clear polymer with about 1% by weight to about 20% by weight of aluminum pigment flake to create metallic looking plastic coatings having enhanced wear resistance properties.

Still yet another composition of the present invention produced using the method of the present invention comprises fluoropolymers, PEEK or polyamide particles approximately 44 μm in diameter size clad with either alumina or chromia particles having a size of about 2 μm to about 10 μm in diameter. In addition, metal alloys such as nichrome can be used in place of or in addition to the alumina or chromia discussed above. When nichrome is used, the particle size ranges from about 2 μm to about 62 μm in diameter, preferably less than 44 μm in diameter. These compositions, when applied using low-heat, provide a surface coating having a plastic matrix with hard particles dispersion therein. The compositions of the present invention including but not limited to the compositions discussed above can be produced by the method of the present invention described below.

Another embodiment of the present invention is directed to a one step cladding process designed to incompletely clad one material with another. One benefit of the process for producing partially clad compositions, such as the compositions of the present invention, is that these compositions can be produced in basically one step. The process of the present invention may optionally use either an organic binder and/or heat softening of the plastic components to attach and clad the inorganic particles to the plastic particles. The major criterion is to insure that a portion of the plastic particle surface area remains unclad. Plastic particles partially clad with metals or ceramics provide the advantage of easy handling and reduce the chance of the inorganic particles separating from the plastic. During spraying, composite particles accelerate less rapidly, pick up more heat and could permit efficient melting of higher melting plastics such as fluoropolymers, such as Teflon® and polyimides and allow higher spray rates.

The one step cladding process of the present invention is directed to the production of compositions combining plastic powders with different plastic powders or inorganic powders so as to produce clad particles intended for low temperature thermal spray processing. Cladding two or more different particles together using the process of the present invention before thermal spraying eliminates the problem of particle separation/classification in the power feeder because of specific gravity differences. In addition, the process of the present invention assures even distribution of various constituents in the sprayed coatings of the present invention. Further, cladding two or more different, but compatible polymers powders, together before extrusion eliminates the need for co-extrusion and the associated regrinding and screening prior to final extrusion.

The cladding process of the present invention comprises dry mixing the different particles in a blender and then optionally adding appropriate binding agents such as polyethylene glycol, starch, polyvinyl pyrilodone PVP, etc. to the mix in order to facilitate the cladding process. In the alternative, the plastic can be slightly heated so as to allow the higher melting point component to adhere to the softened plastic particle and once dried the inorganic particle is firmly clad to the plastic core. Either way, the amounts of the higher and lower melting components can be regulated so as to assure that the resulting composite is incompletely clad with the higher melting component. If an appropriate binding agent is added, a slurry is produced and is allowed to dry, otherwise the mix is allowed to air dry. If a binding agent is used, the mix can be heated to about 125° F. or a temperature below the melting point of lowest melting polymer in order to accelerate drying. The dried composite is then screened to desired size.

Using the process described above, another composition of the present invention having an inorganic core clad with a plastic can be made. In this composition, coarse grit inorganic particles having a diameter ranging from less than or equal to about 40 mesh (420 μm), preferably 80 mesh (177 μm) selected from the group consisting of silicon carbide, crushed glass, flint, sand, alumina, garnet as well as others can be clad with polymers, such as polyethylene having a size of less than about 100 mesh. This composite of coarse grit inorganic particles clad with finer and lighter plastic polymer clad to the outside sprays freely through the powder feeder and allows deposition of grit and plastic of the present invention simultaneously forming a plastic coating matrix embedded with grit. These compositions can be used in high traffic areas and as non-skid coatings.

The composition comprising particles wherein plastic is clad to an inorganic core differs from the compositions having inorganic component(s) clad to a plastic core in that in the later the inorganic component is either completely or incompletely clad to the larger plastic molecule. Unlike the compositions described above where the core is plastic, the size of the plastic is smaller than the inorganic components so that the plastic can completely or incompletely clad to its surface. For example, in a particle wherein plastic is clad to the inorganic component, the inorganic component has a size of about 80 mesh to about 46 mesh, and the plastic component has a size less than about 100 mesh. This assures that the inorganic component is large enough to be clad smaller plastic particles. However, in this composition the inorganic core can be either completely or incompletely clad with the plastic since in either situation the plastic is exposed to the heat so that it can melt but yet can transfer some of the heat to the inorganic core so that it does not vaporize or scorch.

The simultaneous thermal spray deposition of different density materials (coarse inorganic grit and polymer) solves the long existing problem of particle separation associated with compositions of this type. Compositions in which the inorganic component is either completely or incompletely clad to the larger plastic molecule can also be produced by the cladding process of the present invention since the process allows for compositions comprising materials of different density.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A particle for depositing a coating on a substrate surface by a low temperature thermal spray process, the particle comprising:
a plastic core; and
a particulate cladding material selected from the group consisting of ceramics and metals having a higher melting point than said plastic core, wherein said particulate cladding material is adhered to said plastic core and wherein said particulate cladding material forms an incomplete non-continuous cladding layer around said plastic core whereby upon heating, enough heat is transferred to the plastic core to cause it to melt but not vaporize and said particulate cladding material having a higher melting point does not melt.

2. The particle of claim 1, wherein the plastic forming the plastic core is a fluoropolymer, polyvinyl chloride, epoxy resin, polyester, polyethylene, polyamide, polyimides or mixtures thereof.

3. The particle of claim 2, wherein the plastic forming the plastic core is a fluoropolymer selected from the group consisting of polychlorofluoroethylenes, polychlorotrifluoroethylenes, and polyfluorohydrocarbons.

4. The particle of claim 1, wherein the cladding material is selected from the group consisting of metals, metal alloys, metal oxides, metal nitrides, metal carbides, ceramics and mixtures thereof.

5. The particle of claim 4, wherein the cladding material is selected from the group consisting of include, but are not limited to iron, copper, nickel, cobalt, molybdenum, as well as the alloys of any of these metals, tungsten carbide, titania, chromia, Zirconia (ZrO₂), Alumina (Al₂O₃) Hafinia (HfO₂), silicon carbide, vermiculite, garnet and mixtures thereof.

6. The particle of claim 5, wherein the cladding material is about 1 μm to about 70 μm.

7. An article having a thermal sprayed coating, the coating being obtained by:
(a) providing a plurality of particles, each of the particles comprising a plastic core and a particulate cladding material selected from the group consisting of ceramics and metals having a higher melting point than the plastic core, wherein the particulate cladding material is adhered to the plastic core and wherein the particulate cladding material forms an incomplete thermally protective cladding layer around the plastic core so that when heated above the melting point of the plastic core enough heat is transferred to the plastic core to cause it to melt but not to vaporize while the higher melting point particulate cladding material remains unmelted; and
(b) thermally spraying said plurality of particles onto a surface of a substrate under thermal spray conditions that melt the plastic core but not the higher melting point clad material so as to produce a coating whereby said unmelted clad material is embedded in the melted plastic core applied to said article.

8. The article of claim 7, wherein the cladding material is selected from the group consisting of include, but are not limited to iron, copper, nickel, cobalt, molybdenum, as well as the alloys of any of these metals, tungsten carbide, titania, chromia, Zirconia (ZrO₂), Alumina (Al₂O₃) Hafinia (HfO₂), silicon carbide, vermiculite, garnet and mixtures thereof.

9. The article of claim 8, wherein the plastic forming the plastic core of the particles is selected from the group consisting of fluoropolymer, polyvinyl chloride, epoxy resin, polyester, polyethylene, polyamide, polyimide and mixtures thereof.

10. A method for depositing a coating on a surface of a substrate using low temperature thermal spraying, the method comprising the steps of:
(a) providing a substrate having a surface;
(b) providing a clad plastic particle further comprising:
a plastic core and at least one particulate cladding material selected from the group consisting of metals, metal oxides, metal nitrides, metal chlorides, and metal carbides, wherein said at least one particulate cladding material is adhered to said plastic core so as to form an incomplete continuous cladding layer around said plastic core whereby upon heating, enough heat is transferred to the plastic core to cause it to melt but not vaporize and said at least one particulate cladding material remains unmelted, and
(c) spraying an admixture comprising said clad plastic particle on a portion of said surface of said substrate with a thermal spray gun using spraying parameters sufficient to melt but not vaporize said plastic core while said at least one particulate cladding material remains unmelted thereby producing a coating on said surface wherein said at least one unmelted particulate cladding material is embedded in said melted plastic core.

11. The method of claim 10, wherein the plastic core is selected from the group consisting of fluoropolymer, polyvinyl chloride, epoxy resin, polyester, polyethylene, polyamide, polyimide and mixtures thereof.

12. The method of claim 11, wherein the fluoropolymer is selected from the group consisting of polytetrafluoroethylene (PTFE), ethyltetrafluoroethylene (ETFE), tetrafluoroethylene (TFE), perfluoroalkoxy (PFA), Polyvinylidene Difluoride (PVDF) and fluorinated ethyl propylene (FEP).

13. The method of claim 11 wherein plastic core is polyester or polyethylene and the cladding material contains at least one selected from the group consisting of Zirconia (ZrO₂), Alumina (Al₂O₃), Chromia and Hafinia (HfO₂).

14. The method of claim 13, wherein the plastic core is polyethylene or polyester and the clad material contains vermiculite particles.

15. The method of claim 14, wherein the plastic core is fluoropolymer, PEEK or polyamide particles having a diameter size of about 10 μm to about 149 μm clad with at least one inorganic selected from the group consisting of iron, copper, nickel, cobalt, molybdenum, as well as the alloys of any of these metals, tungsten carbide, titania, chromia, Zirconia (ZrO₂), Alumina (Al₂O₃) Hafinia (HfO₂), silicon carbide, vermiculite, garnet and mixtures thereof having a size of about 2 μm to about 74 μm in diameter.

16. The method of claim 12, wherein the plastic core is polyethylene or polyamide clad with about 20% by weight to about 75% by weight of cuprous oxide particles.

17. The method of claim 16, wherein the cuprous oxide particles of this composition are about 1 μm to about 62 μm in diameter and are partially clad to the polyethylene or polyamide.

18. A process for producing a clad composition comprising:
dry mixing at least two different particles wherein one of said particles has a higher melting point than the other and wherein at least one of said particles is added in an amount less than the other so as to assure incomplete cladding of one particle to the other.

19. The process for producing a clad composition according to claim 18 wherein a binding agent is added to said dry mixture so as to aid in one particle binding to another; and optionally heating said mixture with the binding agent to about 125° F. or a temperature below the melting point of lowest melting polymer in order to accelerate drying of said binder.

20. The process for producing a clad composition according to claim 19 wherein the binding agent is selected from the group consisting essentially of polyethylene glycol, water, starch based solution, polyvinyl pyrilodone (PVP) and mixtures thereof.

21. A particle for depositing a coating on a substrate surface by a low temperature thermal spray process, the particle comprising:
an inorganic core having a particle size of at least about 40 mesh (420 μm); and
a plastic particulate cladding material having a particle size of less than about 100 mesh (149 μm) wherein said plastic particulate cladding material is adhered to said inorganic core to form a particle having a continuous or non-continuous plastic layer clad to said inorganic core whereby upon heating, enough heat is transferred to the plastic layer so as to cause it to melt but not vaporize and said inorganic core having a higher melting point does not melt.

22. The particle of claim 21, wherein said plastic particulate is a fluoropolymer, polyvinyl chloride, epoxy resin, polyester, polyethylene, polyamide, polyimides or mixtures thereof.

23. The particle of claim 21, wherein said inorganic core has a particle size of 80 mesh (177 μm).

24. The particle of claim 21, wherein said inorganic core is selected from the group consisting of coarse grit silicon carbide, crushed glass, flint, sand, garnet, aluminum oxide (alumina) and mixtures thereof.
